(19) United States
(12) Patent Application Publication
(10) Pub. No.: US 2020/0017723 A1
(43) Pub. Date: Jan. 16, 2020

(54) PRODUCING A PRESSURE-SENSITIVE ADHESIVE BASED ON SOLID EPDM RUBBER

(71) Applicant: tesa SE, Norderstedt (DE)

(72) Inventors: ANNA SCHUBERT, Norderstedt (DE); JULIA SCHÖNROCK, Hamburg (DE); MAIKE STREBL-PFARR, Hamburg (DE)

(73) Assignee: tesa SE, Norderstedt (DE)

(21) Appl. No.: 16/509,635

(22) Filed: Jul. 12, 2019

(30) Foreign Application Priority Data
Jul. 12, 2018 (DE) 10 2018 211 617.2

(51) Int. Cl. C09J 7/38; C09J 11/08

(52) U.S. Cl. CPC C09J 7/383; C09J 11/08; B29C 48/022; C09J 2409/00; C09J 2491/00; C09J 2205/102

(57) ABSTRACT

A process for the continuous and solvent-free production of a pressure-sensitive adhesive based on solid EPDM rubber, the pressure-sensitive adhesive produced thereby, and an adhesive tape containing the pressure-sensitive adhesive. The pressure-sensitive adhesive is produced in a continuously operating assembly in the form of a planetary roller extruder having a filling section and a compounding section, the compounding section consisting of at least two coupled roller cylinders, by

a) feeding the solid EPDM rubber and any further components into the filling section of the planetary roller extruder,
b) transferring the components from the filling section into the compounding section,
c) adding liquid EPDM rubber, plasticizer, tackifier resin, and any further components to the compounding section, and
d) discharging the resultant pressure-sensitive adhesive,
which process comprises feeding the solid EPDM rubber as a melt into the filling section.

This application claims priority of German Patent Application No. 10 2018 211 617.2, filed Jul. 12, 2018, the entire contents of which are incorporated by reference herein.

The invention relates to a process for the continuous solvent-free production of a pressure-sensitive adhesive on the basis of solid EPDM rubber, to a pressure-sensitive adhesive obtainable by this process, and to a pressure-sensitive adhesive tape which comprises at least one layer of a pressure-sensitive adhesive of this kind.

Pressure-sensitive adhesives (PSAs) have been known for some considerable time. PSAs are adhesives which allow durable bonding to the substrate even at a relatively weak applied pressure and which after use can be detached from the substrate again substantially without residue. At room temperature, PSAs exhibit a permanently adhesive effect, thus having a sufficiently low viscosity and a high tack, and so wetting the surface of the respective bond substrate even with little applied pressure. The bondability of the adhesives and the redetachability are based on their adhesive properties and on their cohesive properties. A variety of compounds are suitable as a basis for PSAs.

Adhesive tapes equipped with PSAs, referred to as pressure-sensitive adhesive tapes, are nowadays put to diverse uses in the industrial and household spheres. Pressure-sensitive adhesive tapes consist customarily of a carrier film which is furnished on one or both sides with a PSA. There are also pressure-sensitive adhesive tapes which consist exclusively of one or more PSA layers and no carrier film, these being referred to as transfer tapes. The composition of the pressure-sensitive adhesive tapes may differ greatly and is guided by the particular requirements of the various applications. The carriers consist customarily of polymeric films such as, for example, polypropylene (PP), polyethylene (PE), polyesters such as polyethylene terephthalate, or else of paper, fabric or nonwoven.

The self-adhesive or pressure-sensitive adhesive compositions consist customarily of acrylate copolymers, silicones, natural rubber, synthetic rubber, styrene block copolymers or polyurethanes.

Ethylene-propylene-diene rubbers, abbreviated as EPDM rubbers, derive from ethylene-propylene-diene, M group, referred to at least terpolymeric synthetic rubbers which are obtained typically by catalytic copolymerization of ethylene, propylene, a diene, and optionally further monomers. EPDM is among the synthetic rubbers having a saturated main chain (according to DIN: M group). They instead possess double bonds in the side chains and are therefore readily crosslinkable. Suitable dienes are nonconjugated dienes whose double bonds have different reactivities. One double bond is to react preferentially in the polymerization and be incorporated into the chain, while the second double bond at the same time remains intact, as far as possible inertly in the side chain and is intended to have sufficiently high reactivity for later crosslinking. The fraction of ethylene is typically 45-75 wt %.

EPDM rubbers are available from a multiplicity of manufacturers such as, for example, Exxon Mobil, Kumho, and Lion Copolymers.

To set properties that are in line with the application, it is possible to modify PSAs by admixing of tackifier resins, plasticizers, crosslinkers or fillers. To improve the capacity of rubbers for processing it is common to admix them with inert release assistants such as talc, silicates (talc, clay, mica), zinc stearate, and PVC powder.

A PSA based on solid EPDM rubber is customarily produced by dissolving the base polymer and the further constituents, such as tackifier resin, for example, in a suitable solvent, and coating the resulting mixture onto a carrier or liner by means, for example, of halftone-roll application, comma bar coating, multiple-roll coating, or in a printing process, after which the solvent is removed in a drying tunnel or drying oven. Particular disadvantages of a solvent process of this kind are a limited coatweight and also the laborious drying.

Alternatively the carrier or liner may also be coated in a solvent-free process. For that purpose the solid EPDM rubber is heated in an extruder with at least part of the tackifier resin to be added, and is melted. Further operating steps may take place in the extruder, such as mixing with further constituents, filtering or degassing. The melt is then coated onto the carrier or liner by means of a suitable application method, using, for example, a nozzle or a calender.

Various methods for producing PSAs are described for example in DE 693 20 359 T2, US 2014/0011945 A1, WO 2015/017400 A1, EP 0 874 034 A1 or DE 10 2008 004 388 A1.

Solvent-free production of PSAs based on solid EPDM has been possible to date provided the fraction of solid EPDM rubber is very high. PSAs with high fractions of solid EPDM such as 50 wt %, for example, can often be produced in a homogeneous form by extrusion. With such high fractions of solid EPDM, however, PSAs typically exhibit low levels of peel adhesion on substrates such as steel, for example. PSAs with relatively low fractions of solid EPDM, such as 30 wt %, for example, exhibit high levels of peel adhesion on a variety of substrates. Because of the relatively high fractions of lubricating components, i.e., soft components, such as, in particular, tackifier resins, and because of the lower shearing forces associated with such components, it is not possible to produce such PSAs in a homogeneous form by an extrusion process, however—that is, PSAs of this kind typically include rubber particles which have not been broken down, and more particularly contain many such particles. This is especially true of EPDM rubbers of high ethylene content. The alternative production by solvent methods has the great disadvantage that it is not suitable for the production of thick adhesive layers.

The object on which the present invention is based is therefore that of providing a process for the solvent-free production of a PSA based on solid EPDM rubber, wherein the resulting PSA is homogeneous and at the same time has a usable peel adhesion on diverse substrates.

The object is achieved, surprisingly, by a process as described in claim 1. Advantageous embodiments of the process are found in the dependent claims.

The invention relates accordingly to a process for the continuous and solvent-free production of a pressure-sensitive adhesive based on solid EPDM rubber in a continuously operating assembly in the form of a planetary roller extruder having a filling section and a compounding section, the compounding section consisting of at least two coupled roller cylinders, by

a) feeding the solid EPDM rubber and any further components into the filling section of the planetary roller extruder,
b) transferring the components from the filling section into the compounding section,
c) adding liquid EPDM rubber, plasticizer, tackifier resin, and any further components to the compounding section, and
d) discharging the resultant pressure-sensitive adhesive,
which process comprises
feeding the solid EPDM rubber as a melt into the filling section.

Since the process of the invention is solvent-free, it is highly suitable for producing PSA layers in various thicknesses, including, in particular, high thicknesses. There is no laborious drying in the production process. In particular, it is possible through the process of the invention to produce PSAs which are homogeneous and at the same time exhibit a useful peel adhesion on diverse substrates. This refers typically to PSAs which exhibit a high peel adhesion on substrates differing in polarity, such as, for example, on polar substrates such as steel or on apolar substrates, i.e., LSE (low surface energy) surfaces, such as polypropylene or polyethylene. The levels of peel adhesion are comparable with those of corresponding PSAs produced by the solvent process.

Surprisingly it has therefore been found that the prior melting of the solid EPDM rubber, in accordance with the invention, in the process illustrated, even when using a relatively low fraction of solid EPDM, affords PSAs based on solid EPDM rubber that are homogeneous.

It is also surprising that the process of the invention, in contrast to the solvent process, also permits production of homogeneous PSAs based on solid EPDM rubber having a relatively high ethylene content, such as, in particular, of more than 55 to 62 wt %. The viscoelastic properties of EPDM are determined substantially by the ethylene content, since polyethylene has a strong tendency to crystallize. Polymers with an ethylene content of between 40 and 55 wt % are amorphous and have the best low-temperature flexibility. As the ethylene content rises, the crystallinity increases. An EPDM with medium ethylene content of 55 to 65 wt % is semicrystalline. Polymers with more than 65 wt % of ethylene have substantial crystalline regions and behave like thermoplastic elastomers; even in the noncrosslinked state, they have a high tear strength, which with rising ethylene fraction may be up to 12 MPa. Homogeneous PSAs based on semicrystalline solid EPDMs can be achieved by means of the process of the invention even when the fraction of solid EPDM is relatively low.

The present invention also relates, correspondingly, to a pressure-sensitive adhesive based on solid EPDM rubber which comprises liquid EPDM rubber, plasticizer, and tackifier resin, wherein the solid EPDM rubber is composed to an extent of 55 to 75 wt %, preferably 55 to 65 wt %, as for example greater than 55 to 62 wt %, of ethylene, based on the total weight of the parent monomer composition. The advantageous embodiments of the process of the invention which relate to nature and amount of the components employed are also valid, correspondingly, in respect of the stated PSA.

The present invention relates, moreover, to a pressure-sensitive adhesive which is obtainable by the process of the invention, and also to a pressure-sensitive adhesive tape which comprises at least one layer of a pressure-sensitive adhesive of this kind. The advantageous embodiments of the process of the invention are also valid, correspondingly, for the stated PSA and also the stated pressure-sensitive adhesive tape.

As described above, the PSAs of the invention are typically homogeneous. In the context of the present specification, the testing of a PSA for homogeneity is carried out as follows: 5 g of the PSA are taken after exit from the planetary roller extruder and are pressed between two process liners by means of a hot press at 110° C. and a pressure of 5 bar. Process liners used in this case are PET films 75 μm thick which on either side have a coating of differently graduated silicone systems. After cooling, the pressed system is pulled apart, with the result that the PSA layer thus formed has a thickness of approximately 50 μm. The layer is held in front of a lamp. It is termed homogeneous if, over an extended area of 100 cm², less than 10, preferably less than 5, and more particularly less than 2 rubber particles which have not been broken down can be found using the eye. In the stated test, furthermore, there should be no visible lubricating components such as unincorporated tackifier resin. Lubricating components in accordance with the invention are, in particular, tackifier resins, plasticizers, and liquid EPDM rubber. Tackifier resins may not melt until during the compounding operation on exposure to shearing energy and/or to external heating.

In the context of this specification, moreover, the term “melt” refers in particular to a condition in which a component, such as, in particular, solid EPDM rubber, or a mixture of components, is plastically deformable. Because of the typically elastic nature of the polymer or polymers and because of the absence of thermoplastic behavior, no melted condition is in this case reached where the behavior present is that of a liquid. In the case of a mixture, the behavior relates to the homogeneous mixture and not to the individual mixture components, which may well be present in the liquid condition.

Liquid rubbers are notable in relation to solid rubbers in that they have a softening point Tₛ of less than 40° C. Solid rubbers are therefore characterized in that they do not have a softening point Tₛ of less than 40° C. “Solid rubber components” in accordance with the present invention are therefore solid at room temperature, even if in accordance with the invention they are melted before being fed to the extruder.

A pressure-sensitive adhesive based on solid EPDM rubber typically means a PSA whose polymer consists to an extent of at least 50 wt % of solid EPDM rubber, based on the entire polymer contained in the PSA. In one preferred embodiment the polymer contained in the PSA consists to an extent of 90 wt %, more preferably more than 95 wt %, and more particularly 100 wt %, of solid, and optionally liquid, EPDM rubber. In the context of the present specification, tackifier resins are considered here to be polymers.

The solid EPDM rubber is composed preferably to an extent of 30 to 80 wt %, more preferably 40 to 75 wt %, more preferably still 45 to 70 wt %, more particularly 55 to 65 wt %, as for example greater than 55 to 62 wt %, of ethylene, based in each case on the total weight of the parent monomer composition.

The solid EPDM rubber is composed preferably to an extent of 20 to 60 wt %, more preferably 30 to 50 wt %, of propylene, based in each case on the total weight of the parent monomer composition.

The solid EPDM rubber is composed preferably to an extent of up to 20 wt %, more preferably 5 to 10 wt %, of diene, based in each case on the total weight of the parent monomer composition. The diene content of commercial products is between 2 and 12 wt %, corresponding to a fraction of 3 to 16 double bonds per 1000 carbons. A higher diene content produces a higher crosslinking rate, a higher crosslinking density, higher strengths, and a lower permanent deformation. Conversely, the aging resistance, weathering resistance, and ozone resistance go down as the diene content rises. The diene is preferably ethylidene-norbornene (ENB), dicyclopentadiene or 1,4-hexadiene.

The Mooney viscosity (ML 1+4/125° C.) of the solid EPDM rubber as measured according to DIN 53523 is preferably 20 to 120, more preferably 40 to 90, and more particularly 50 to 80.

In the process of the invention the fraction of solid EPDM rubber is preferably at least 15 wt %, more preferably 20 to 45 wt %, more particularly 25 to less than 40 wt %, as for example 28 to 35 wt %, based on the total weight of the pressure-sensitive adhesive to be produced. When comparatively low fractions of solid EPDM rubber are used it is possible to produce PSAs having particularly good levels of peel adhesion on surfaces of differing polarity such as, for example, steel, polypropylene or polyethylene.

The liquid EPDM rubber is preferably composed to an extent of 30 to 70 wt %, more preferably 40 to 68 wt %, of ethylene, based in each case on the total weight of the parent monomer composition. Furthermore, the liquid EPDM rubber preferably has a weight-average molar weight M_{w}, ≤100 000 Da, more preferably ≤50 000 Da, more preferably still ≤30 000 Da, and more particularly ≤20 000 Da.

In the process of the invention the fraction of liquid EPDM rubber is preferably up to 30 wt %, more particularly 10 to 20 wt %, based on the total weight of the pressure-sensitive adhesive to be produced. Likewise preferably the liquid EPDM rubber is used in an amount of up to 100 phr, preferably 33 to 67 phr.

The FIGURES in phr (parts per hundred rubber) given in the present specification each denote parts by weight of the respective component relative to 100 parts by weight of all the solid rubber components of the PSA, thus, for example, disregarding tackifier resin or liquid rubber.

Plasticizers are plasticizing agents such as, for example, plasticizer resins, phosphates or polyphosphates, paraffinic and naphthene oils, oligomers such as oligobutadienes, and oligoisoprenes, liquid terpene resins, and vegetable and animal oils and fats. Plasticizer resins may have the same chemical basis as the tackifier resins employable in accordance with the invention, but differ from them in their softening point, which is typically <40° C. Employed with particular preference as plasticizers as in the process of the invention are white oils. White oils are paraffinic oils, thus containing paraffin. Besides paraffinic constituents, they frequently include naphthenic constituents. They preferably contain no aromatic constituents and no sulfur compounds. If oil is employed as plasticizer, the oil in question may be mineral oil or synthetic oil.

The fraction of plasticizer used in the process of the invention is preferably up to 20 wt %, more particularly between 5 and 15 wt %, based in each case on the total weight of the pressure-sensitive adhesive to be produced. Also preferably the plasticizer is used in amount of up to 67 phr, preferably 17 to 50 phr.

One of the components used in the process of the invention is tackifier resin. The designation “tackifier resin” is understood by the skilled person to be a resin-based substance which increases the tackiness. Typical softening points Tₛ of tackifier resins are at least 40° C.

As tackifier resins in the process of the invention it is possible for example to use hydrogenated or unhydrogenated hydrocarbon resins (C9 or C5 resins such as, for example, Regalite).

Also suitable and preferred are modified hydrocarbon resins such as, for example, modified C9 resins having a DACP of less than −30° C.

It is also possible to use combinations of the aforesaid tackifier resins and further suitable tackifier resins, in order to set the desired properties of the resultant PSA. Reference may expressly be made to the depiction of the state of knowledge in the “Handbook of Pressure Sensitive Adhesive Technology” by Donatas Satas (van Nostrand, 1989). The skilled person is familiar with which resins are to be selected preferentially as a function of the properties of the EDPM rubber, particularly the ethylene content. Preferred tackifier resins have a DACP of less than −20° C., more preferably less than −40° C., and more particularly less than −60° C.

If the tackifier resin in the process of the invention is used in an amount of in total 30 to 180 phr, then the resulting PSA is at the same time, in particular, characterized by good adhesion and cohesion values. The tackifier resin is used preferably in an amount of 90 to 170 phr, more preferably 100 to 160 phr. By this means it is typically possible at the same time to obtain particularly good adhesion and cohesion values on the part of the resultant PSA. Likewise preferably, accordingly, the tackifier resin is used in an amount of 9 to 54 wt %, more preferably of 27 to 51 wt % and more particularly of 30 to 48 wt %, based in each case on the total weight of the resulting PSA.

When using the specific preferred amounts of the lubricating components (liquid EPDM rubber, plasticizer, tackifier resin), it is possible in accordance with the invention to produce particularly homogeneous adhesives.

Besides the solid EPDM rubber, the liquid EPDM rubber, the plasticizer, and the tackifier resin, it is possible in particular to make use as further components, especially for adjusting the optical and technical adhesive properties, of fillers, dyes, aging inhibitors, flame retardants and/or crosslinkers. In accordance with the invention, crosslinking promoters are also considered to be crosslinkers. The further components may be fed into the filling section of the planetary roller extruder and/or be added to the compounding section.

Fillers are used for example for boosting the cohesion of a PSA. Fillers may also improve the incorporation of the polymers used. Fillers are also admixed for the purpose of increasing weight and/or volume. The addition of filler oftentimes improves the technical usefulness of the products and has an influence on their quality—for example, strength, hardness, etc. The natural inorganic and organic fillers such as calcium carbonate, kaolin, dolomite and the like are produced mechanically. With rubber as well it is possible, by means of suitable fillers, to improve the quality—thus, for example, hardness, strength, elasticity, and elongation. Fillers in widespread usage are carbonates, especially calcium carbonate, but also silicates (talc, clay, mica), siliceous earth, calcium sulfate and barium sulfate, aluminum hydroxide, glass fibers and glass spheres, and also carbon blacks.

Inorganic and organic fillers can also be differentiated according to their density. Hence the inorganic fillers often used in adhesives, such as chalk, titanium dioxide, and calcium and barium sulfates, increase the density of the composite.

The aging inhibitors are, in particular, antiozonants, primary antioxidants such as, for example, sterically hindered phenols, secondary antioxidants such as, for example, phosphites or thioethers, or light stabilizers such as, for example, UV absorbers or sterically hindered amines.

The crosslinker may for example be a thermally activatable crosslinker, selected for example from the group of the reactive phenolic resin or diisocyanate crosslinking systems. In accordance with the invention the thermally activatable crosslinker is not typically activated until a temperature which is higher than the temperature of the compound in the compounding section of the planetary roller extruder, at least on or after addition of the crosslinker. In accordance with the invention the thermal crosslinker is activated preferably above 140° C. and in particular above 150° C. Otherwise a considerable increase in viscosity is likely, owing to chemical crosslinking reactions ensuing in the compounding section, with the result that the resultant PSA suffers a loss of coatability and therefore can no longer be applied to a material in web form. In one preferred embodiment the PSA of the invention may be crosslinked by means of electron beams; that is, EBC crosslinking may be carried out. The EBC crosslinking may be carried out with or without a crosslinking promoter. The use of a crosslinking promoter is preferred. In that case the promoter in question may be, for example, a polyfunctional (meth)acrylate such as trimethylolpropane triacrylate (TMPTA).

The process for producing a pressure-sensitive adhesive based on solid EPDM rubber is carried out in a planetary roller extruder having a filling section and a compounding section, the compounding section consisting of at least two coupled roller cylinders.

Planetary roller extruders consist of a plurality of parts, namely a revolving central spindle, a housing surrounding the central spindle at a distance and having an internal set of teeth, and planetary spindles, which revolve like planets about the central spindle in the cavity between central spindle and internally toothed housing. Where reference is made hereinafter to an internal toothing of the housing, this also includes a multipart housing with a bush that forms the internal toothing of the housing. In the planetary roller extruder, the planetary spindles engage both with the central spindle and with the internally toothed housing. By their ends facing in the conveying direction, the planetary spindles likewise slide on a check ring. In comparison to all other kinds of extruder design, the planetary roller extruders possess an extremely good mixing action, but a much lower conveying action.

Planetary roller extruders were first employed in the processing of thermoplastics such as PVC, for example, where they were used primarily for charging the downstream units such as, for example, calenders or roll mills. Because of their advantage of the substantial surface renewal for mass exchange and heat exchange, allowing the energy introduced by way of friction to be taken off rapidly and effectively, and also by virtue of the low residence time and the narrow residence-time spectrum, they have more recently expanded their field of use to include, among others, compounding operations which require a particularly temperature-controlled regime.

Planetary roller extruders vary in sizes and designs according to manufacturer. Depending on the desired throughput, the internal diameters of the roller cylinders, i.e., roller cylinder diameters, are typically between 70 mm and 400 mm.

For the processing of plastics, planetary roller extruders generally have a filling section and a compounding section.

According to a first alternative, the filling section of the planetary roller extruder used has a conveying screw to which the solid EPDM rubber and any further components are continuously metered. The conveying screw then transfers the material to the compounding section of the planetary roller extruder. The region of the filling section with the screw is preferably cooled to below 20° C., for example to 5 to 18° C. and more particularly 8 to 15° C., in order as far as possible to prevent materials caking on the screw. There are, however, also embodiments without a screw part, in which the material is fed directly between central spindle and planetary spindles. For the effectiveness of the process of the invention, this is unimportant. The central spindle as well is cooled preferably to below 20° C., for example to 5 to 18° C., and more particularly 8 to 15° C., in order as far as possible to prevent caking of material on the central spindle. The central spindle here is cooled typically with a medium such as water or oil, for example. Also preferred is the thermal conditioning of the central spindle at 20 to 30° C.

The compounding section consists of a driven central spindle and a plurality of planetary spindles, which revolve about the central spindle within one or more roller cylinders with internal helical gearing. The rotary speed of the central spindle and hence the peripheral velocity of planetary spindles can be varied and is therefore an important parameter for control of the compounding operation.

The surrounding housing has, in its contemporary form, a double jacket. The inner jacket is formed by a bush which is provided with the internal toothing. The important cooling of the planetary roller extruder is provided between the inner and outer jackets.

The planetary spindles do not require any guiding in peripheral direction. The gearing ensures that the distance between the planetary spindles in the circumferential direction remains the same. They are, so to speak, self-guided.

The materials are circulated between central and planetary spindles and/or between planetary spindles and helical gearing of the roller section, so that, under the influence of shearing energy and external heating, the materials are dispersed to form a homogeneous compound.

The number and type of the planetary spindles that rotate in each roller cylinder can be varied and hence adapted to the requirements of the operation. The number and type of spindles influences the free volume within the planetary roller extruder and the residence time of material in the operation, and determines, moreover, the size of the surface for heat exchange and material exchange. The number and nature of the planetary spindles, by way of the shearing energy introduced, has an influence on the outcome of compounding. Given a constant roller cylinder diameter, it is possible, with a greater number of spindles, to obtain a better homogenization and dispersion performance, or a greater product throughput. According to the present invention, in order to obtain a good balance between quality of compounding and product rate, preferably at least half, more preferably, indeed, at least ¾, of the possible number of planetary spindles are to be used. Of course, each roller cylinder may be equipped differently in terms of the number and nature of the planetary spindles, and so may be adapted to the particular requirements of the specific formula and technical process.

The maximum number of planetary spindles that can be installed between the central spindle and roller cylinder is dependent on the diameter of the roller cylinder and on the diameter of the planetary spindles used. Where relatively large roller cylinder diameters are used, of the kind necessary for achieving throughput rates on the production scale, or when using smaller diameters for the planetary spindles, the roller cylinders may be fitted with a large number of planetary spindles. Typically, in the case of an internal diameter of the roller cylinder of 70 mm, up to seven planetary spindles are used, whereas, for a roller cylinder internal diameter of 200 mm, for example, ten planetary spindles and, for a roller cylinder internal diameter of 400 mm, for example, 24 planetary spindles may be used.

It has emerged as being advantageous to use a planetary roller extruder whose compounding section consists of two to eight coupled roller cylinders, preferably of three or four coupled roller cylinders.

Both liquid and solid components can be added to the compounding section via side feeders. The roller cylinders are typically provided in approximately the middle of the cylinders with an opening for side feeding. Likewise suitable and preferred, alternatively, are side feeders after approximately of each cylinder. Liquids are added to the compounding section customarily via side feeders and/or check rings and/or injection rings with preferably radial bores. Between two interconnected roller cylinders there is generally a check ring through whose free cross section the central spindle leads and which holds the planetary spindles of a roller cylinder in fixed location. By way of dispersing rings employed additionally, check rings may have different free cross sections, thereby making it possible to vary the holdup of the product and hence the degree of filling and the residence time, and/or the extent of shearing energy, and to adapt them to the operational requirements. The check rings may additionally be provided with radial bores, via which it is possible to supply liquids or else protective gases such as nitrogen, argon, carbon dioxide or the like to the compounding section of the planetary roller extruder. Components in this way can be added to the first roller cylinder via the injection ring located between the filling section and the first roller cylinder; to the second roller cylinder via the first check ring, to the third roller cylinder via the second check ring; and so on.

Customarily the roller cylinders are separately temperature-controllable roller cylinders, thus enabling a balanced temperature regime in the operation, which permits, for example, the use of thermally activatable crosslinker systems. The central spindle and each roller cylinder ought preferably to possess one or more separate temperature-control circuits or cooling circuits, in order to enable a temperature regime that permits the use of thermally activatable crosslinking systems. In cases where this is unnecessary, the temperature-control circuits of interconnected roller cylinders may also be connected to one another in order to minimize the number of temperature-control devices.

The wall temperature of the roller cylinders independently of one another is preferably less than 160° C., more preferably 80 to 150° C., such as, in particular, 100 to 140° C. Via the wall temperature of the roller cylinders it is possible in particular to control the input of process heat. At the wall temperatures stated it is possible to produce PSAs which typically are particularly homogeneous and at the same time are subject at most to slight mastication.

The energy input is also influenced by the configuration of the planetary roller extruder. Via the rotary speed of the central spindle of the planetary roller extruder it is possible in turn to control in particular the input of shearing energy and the overall residence time of the composition in the planetary roller extruder. As well as the wall temperature of the roller cylinders and the type of extruder used, therefore, the energy input is also influenced by the rotary speed of the central spindle. In accordance with the invention, any reduction or increase in the wall temperature of the roller cylinders can typically be countered by an opposing change in the rotary speed of the central spindle, in order to obtain a PSA having a comparable profile of properties.

In particular, however, the rotary speed is altered on transition from smaller to larger machines and throughputs; typically a smaller machine (that is, one having a smaller internal diameter of the roller cylinders) is operated with a higher rotary speed, in order to obtain a comparable outcome to a larger machine (that is, one having a larger internal diameter of the roller cylinders) with a lower rotary speed. The skilled person is familiar with such scale-up adaptions in relation to machine size and material throughput.

Another characteristic of the planetary roller extruder, however, is that the temperature of the processed composition is controlled very effectively by way of the housing temperatures that are set, and, as a general rule, the temperature control is better than in the case, for example, of a twin-screw extruder. With a planetary roller extruder, therefore, it is often also possible, in the case of a scale-up step, to operate with similar wall temperatures, even if the rotary speed is changed significantly.

On exit from the planetary roller extruder, the PSAs typically have temperatures less than 170° C., preferably of 80 to 150° C., more preferably of 90° C. to 140° C., such as, in particular, 100 to 120° C. The exit temperature of the PSA is determined typically by means of penetration sensors in the product exit.

Suitable planetary roller extruders are described for example in EP 2 098 354 A1, WO 2017/050400 A1, WO 2016/124310 A1 and WO 2014/056553 A1.

### BRIEF DESCRIPTION OF THE DRAWING

FIG. 1 shows the planetary roller extruder configuration used in the examples. The examples used a planetary roller extruder from ENTEX Rust & Mitschke.

The planetary roller extruder has a filling section (2) and a compounding section (5), which consists of three roller cylinders (5a-5c) connected in series. Within a roller cylinder, the planetary spindles (7) driven by the rotation of the central spindle (6) exchange the materials between central spindle (6) and planetary spindles (7) and, respectively, between planetary spindles (7) and the wall (10) of the roller cylinder (5a-5c).

At the end of each roller cylinder (5a-5c) there is a check ring (8a-8c) which holds the planetary spindles (7) in fixed location. Optionally there are additionally dispersing rings at these points.

Via the filling opening (1) it is possible to meter components such as, for example, the solid EPDM rubber onto the conveying screw (3) of the filling section (2) of the planetary roller extruder. The conveying screw (3) thereafter transfers the materials to the central spindle (6) of the first roller cylinder (5a). To improve the intake of material between central spindle (6) and planetary spindles (7), four long and three short planetary spindles (7) are used in the first roller cylinder (5a).

The internally hollow conveying screw (3) and central spindle (6) are force-fittingly connected to one another and possess a common temperature-control circuit. Each roller cylinder (5a-5d) of the compounding section (5) possesses an independent temperature control system. The filling section (2) can be cooled via a further temperature-control circuit.

Water may be used as temperature-control medium.

The metering of liquids such as, for example, liquid EPDM rubber, plasticizer, liquid tackifier resin and/or crosslinker may take place, for example, via the injection ring (4) upstream of the first roller cylinder (5a), or via the check rings (8a-8c) provided with bores, or by a combination of both possibilities. The roller cylinders (5a-5c) are provided in approximately the middle of the cylinders with an opening for side feeding. By way of this opening it is possible as and when necessary to add liquid or solid components via side feeders (9a-9c).

The temperature of the PSA is ascertained by means of penetration sensors in the product exit (11).

Before being fed to the filling section, the solid EPDM rubber is melted in an extruder, preferably a single-screw extruder (SSE), at a wall temperature, for example, of 180 to 200° C., such as, in particular, at 190° C. The optimum wall temperature is typically dependent on the crystalline fraction of the solid EPDM rubber: as the crystallinity goes up, rising temperatures are customarily selected. Melting may also take place in a twin-screw extruder or any other desired extruder.

The examples used a Blaake ES45/25D single-screw extruder. The maximum screw speed of this extruder is 124 revolutions per minute. The screw diameter is 45 mm, the screw length 25×D (D=screw diameter).

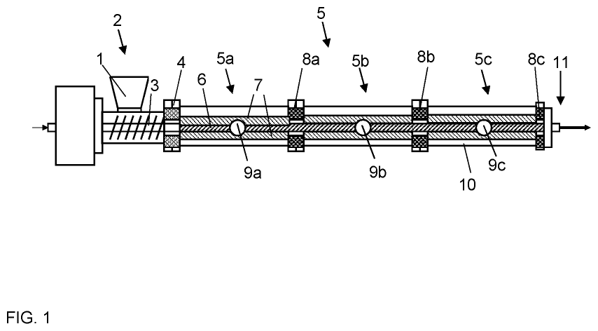

In the case of the exemplary apparatus for the process of the invention, therefore, in addition to the planetary roller extruder shown in FIG. 1, there is a further extruder, in which the solid EPDM rubber is melted before it is introduced via the filling opening (1) into the filling section (2) and so is supplied as a melt to the planetary roller extruder.

In accordance with the invention the compounding section is fed with liquid EPDM rubber, plasticizer, tackifier resin, and any further components. The stated (lubricating) components may be added to the compounding section, independently of one another, in one or more portions. It is preferred in accordance with the invention, particularly on grounds of process economics, for the components to be added to the compounding section each in a single portion. One or more of the stated (lubricating) components may proportionally also be fed together with the solid EPDM rubber and any further components into the filling section of the planetary roller extruder. In the process according to the present invention, moreover, the components may be fed or added as separate components, as a joint premix, or as partial premixes. For example, any further components used, such as crosslinkers, for example, may be fed or added as a mixture with the solid EPDM rubber or with a lubricating component, such as plasticizer, for example.

In contrast to otherwise customary production processes, it is assumed that in the planetary roller extruder, in accordance with the process of the present invention, there is at most slight mastication of the rubber, since the rubber here is not subjected separately to the influence of high shearing energy, but is instead processed together with the lubricating components. By virtue of the presence of these lubricating components, the extent of frictional energy is limited in such a way that the mastication of the rubber, i.e. the breakdown in molecular weight of the elastomers, can be kept low and also high resultant compounding temperatures can be avoided. It is preferred, accordingly, if the first lubricating component or at least a part thereof is fed or added to the filling section or to the first roller cylinder of the compounding section, typically via the injection ring located between the filling section and first roller cylinder, or via a side feeder. With particular preference the first lubricating component is added to the first roller cylinder by way of the injection ring.

The lubricating components can be added to the planetary roller extruder at the same location or at different locations. Typically they are added to the planetary roller extruder at different locations, with positive consequences for the homogeneity of the resultant adhesive. The sequence of the addition here may, in accordance with the invention, be arbitrary. The first lubricating component fed or added is, in accordance with the invention, preferably the liquid EPDM rubber. Likewise, preferably the next, i.e., second lubricating component which is added downstream to the planetary roller extruder is the plasticizer.

The second lubricating component is preferably added to the second roller cylinder of the compounding section, typically via the first check ring, which is located between the first and second roller cylinders, or via a side feeder. With particular preference the second lubricating component is added via a side feeder to the second roller cylinder. Likewise preferably the third lubricating component, which is added downstream to the planetary roller extruder, is the tackifier resin. The third lubricating component is preferably added to the third roller cylinder of the compounding section, typically via the second check ring, which is located between the second and third roller cylinders, or via a side feeder. With particular preference the third lubricating component is added to the third roller cylinder via the second check ring, which is located between the second and third roller cylinders; this is especially the case when the compounding section consists only of three roller cylinders.

The compounding section of the planetary roller extruder used, or the process according to the invention, is preferably designed such that the composition obtained following addition of the last (lubricating) component passes at least one further roller cylinder. This promotes complete incorporation of the rubber and/or the desired homogenizing and dispersing performance at economic throughput rates. Accordingly, in accordance with the invention, the compounding section of the planetary roller extruder consists preferably of three or four coupled roller cylinders.

The tackifier resin may be added or fed as solid or liquid tackifier resin. The tackifier resin is preferably added or fed as liquid tackifier resin, in order to produce a particularly homogeneous adhesive. The adding or feeding of liquid tackifier resin means in accordance with the invention that the tackifier resin is added or fed above its softening point Tₛ—for example, 20 to 40° C. above its softening point Tₛ. The feeding or adding of solid tackifier resin means in accordance with the invention, therefore, that the tackifier resin is added or fed below its softening point Tₛ. Solid and liquid tackifier resin may in accordance with the invention therefore be the same tackifier resin, which is solid or liquid, however, according to the temperature of use. In accordance with the invention the tackifier resin may also be used in the form of a resin split, with parts of the tackifier resin being fed, for example, together with the solid EPDM rubber and any further components into the filling section of the planetary roller extruder.

In the process of the invention, after discharge from the planetary roller extruder, the PSA may be coated at least one-sidedly onto a material in web form, i.e., a web-form carrier.

Web-form carrier materials for the high-performance PSAs produced in accordance with the invention, depending on the intended use of the adhesive tape to be provided, are all known carriers, where appropriate with corresponding chemical or physical surface pretreatment of the coating side and also antiadhesive physical treatment or coating of the reverse side. Examples include creped and uncreped papers, polyethylene films, polypropylene films, mono- or biaxially oriented polypropylene films, polyester films such as PET films, PVC films and other films, web-formed foams, composed of polyethylene and polyurethane, for example, fabrics, knits, and nonwovens. Lastly the web-form material may be an antiadhesive material or double-sidedly antiadhesive coated material such as release papers or release films. The web-form material may therefore be a permanent carrier or a temporary carrier, i.e., a liner. In accordance with the invention the temporary carriers are not considered a constituent of a pressure-sensitive adhesive tape.

In conjunction with a downstream coating unit and optionally crosslinking unit, therefore, the process of the invention allows the production of high-performance pressure-sensitive adhesive tapes. In this case the pressure-sensitive adhesive produced in accordance with the invention is coated at least one-sidedly onto a web-form material without solvent, using an applicator. The present invention also relates, accordingly, to a pressure-sensitive adhesive tape which comprises at least one layer of a pressure-sensitive adhesive preparable by the process of the invention.

The coating unit is preferably a calender or a nozzle through which the adhesive is applied to a carrier material. Calenders enable the adhesive to be shaped to the desired thickness on passage through one or more roll nips.

Proposed in accordance with the invention is the coating of the adhesives, produced in accordance with the invention, with a multi-roll applicator. Such applicators may consist of at least two rolls having at least one roll nip up to five rolls with three roll nips.

In order to improve the transfer behavior of the shaped layer of composition from one roll to another, it is possible, furthermore, to employ halftone rolls or rolls that are furnished antiadhesively. In order to generate a sufficiently precisely shaped film of adhesive, there may be differences in the peripheral velocities of the rolls.

The preferred 4-roll applicator is formed of a metering roll, a doctor roll, which determines the thickness of the layer on the carrier material and which is arranged parallel to the metering roll, and a transfer roll, which is located below the metering roll. On the placement roll, which together with the transfer roll forms a second roll nip, the composition and the web-form material are brought together.

Depending on the nature of the web-form carrier material to be coated, coating may take place in a co-rotational or counter-rotational process.

The shaping assembly may also be formed by a nip which is formed between a roll and a fixed doctor. The fixed doctor may be a knife-type doctor or else a stationary (half-)roll.

A further preferred example is a 3-roll applicator made up of two rolls for application of composition and a chill roll, with the rolls for application of composition having a temperature preferably of 80 to 160° C., more preferably 100 to 140° C., and the chill roll having a temperature preferably of less than 20° C., preferably less than 10° C., with the temperature of the second roll for application of composition typically being lower than that of the first roll for application of composition.

A further preferred application process encompasses coating between two web-form carrier materials, with the adhesive being shaped on a two-roll calender between these two carrier materials. The roll temperatures are typically between 60 and 140° C. The carrier materials in this case are preferably antiadhesively furnished, such as siliconized PET or paper, for example.

In a preferred embodiment of the process of the invention there is a melt pump or an extruder for conveying adhesive, more particularly a degassing extruder such as a twin-screw extruder, for example, between the planetary roller extruder and the coating apparatus employed, and this melt pump or extruder is operated with speed regulation or pressure regulation, preferably with pressure regulation. In order to obtain a defined, full-area coatweight on the web-form material, i.e., web-form carrier, during coating, it is advantageous if the pressure-sensitive adhesive, before entry into a coating nozzle and/or a calender, is subjected to degassing, this being particularly important in the case where protective gases are used during the compounding operation in the planetary roller extruder. According to the process of the present invention, the degassing takes place under the influence of reduced pressure, preferably in screw sheets which are likewise able to overcome the pressure losses of the pipelines and coating nozzle.

In a further preferred embodiment of the process of the invention, the PSA is crosslinked in a step downstream of the coating operation, in which case the PSA is crosslinked preferably by means of electron beams (EBC crosslinking). In this case, optionally, a crosslinking promoter is employed. Crosslinking the PSA has the advantage in particular that it further increases the shear strength, even at elevated temperatures such as, for example, 70° C. or 80° C.

Alternatively it is possible to carry out crosslinking under the effect of temperature, i.e., thermally, in which case corresponding thermally activatable crosslinkers must be added to the PSA. The heating of the PSA that is necessary for this purpose may be accomplished by means of the existing technologies, more particularly by means of high-temperature tunnels, or else with the aid of infrared emitters or by means of high-frequency magnetic alternating fields, as for example HF waves, UHF waves or microwaves. Thermal crosslinking is of particular interest in the case of EBC-sensitive carriers. EBC crosslinking and thermal crosslinking may also be combined.

The concept of the invention, as explained above, also embraces a pressure-sensitive adhesive tape which is produced using a pressure-sensitive adhesive producible by the process of the invention, by applying the pressure-sensitive adhesive to at least one side, optionally also both sides, of a material in web form.

Using the PSA of the invention it is possible accordingly to produce not only single-sidedly adhesive, i.e., one-sided, but also double-sidedly adhesive, i.e., double-sided, pressure-sensitive adhesive tapes. If the PSA of the invention is applied to one side of a permanent carrier, the result is a single-sided adhesive tape. If the PSA of the invention is applied to both sides of a permanent carrier, the result is a double-sided adhesive tape. Alternatively a single-sided pressure-sensitive adhesive tape of this kind can also be produced by applying the PSA of the invention to a liner, and subsequently laminating the resultant PSA layer onto the permanent carrier. A double-sided pressure-sensitive adhesive tape of this kind can also be produced, alternatively, by applying the PSA of the invention to a liner, and subsequently laminating the resultant PSA layer onto both sides of the permanent carrier. After the PSA of the invention has been applied to a liner, the resultant PSA layer may alternatively be laminated onto a further liner. A single-layer, double-sidedly self-adhesive tape of this kind, i.e., double-sided adhesive tape, is also referred to as transfer tape.

The thickness of the PSA on the web-form material may typically be between 10 μm and 5000 μm, and is preferably between 15 μm and 150 μm. In a transfer tape, moreover, the thickness of the PSA is preferably 800 μm to 1200 μm. A transfer tape of this kind has diverse possible applications, particularly after crosslinking.

The invention is elucidated in more detail below by means of examples. The examples described hereinafter provide further elucidation of particularly advantageous versions of the invention, without any intention thereby to subject the invention to unnecessary limitation.

### EXAMPLES

A planetary roller extruder from Entex Rust & Mitschke was used, having three coupled roller cylinders, which had an internal diameter of 70 mm. The first two roller cylinders were fitted in each case with 7 planetary spindles, the subsequent roller cylinder with 6 planetary spindles, with one of the spindles having the geometric shape of a mixing element. In the present embodiment, the planetary roller extruder, the filling section has a conveying screw onto which the material can be metered. The temperature-control medium used for the central spindle and the filling zone in each of the experiments was water with entry temperature of 15° C.

The raw materials used are characterized as follows (table 1):

TABLE 1
raw materials used.

| | Tradename | Manufacturer |
|---|---|---|
| Solid EPDM (ethylene | Vistalon ® 6602 | Exxon Mobil |
| content: 55 wt %; ENB | | |
| content: 5.2 wt %, Mooney | | |
| (ML, 1 + 4 125° C.): 80) | | |
| Solid EPDM (ethylene | Royalene ® 563 | Lion Copolymers |
| content: 57 wt %; ENB | | |
| content: 4.5 wt %; Mooney | | |
| (ML, 1 + 4 125° C.): 75) | | |
| Liquid EPDM | Trilene ® 67 | Lion Copolymers |
| (ethylene/propylene weight | | |
| ratio: 46:54, ENB content: | | |
| 9.5 wt %) | | |
| Hydrogenated hydrocarbon | Regalite ® R 1100 | Eastman |
| resin (softening temperature: | | |
| 100° C.) | | |
| Trimethylolpropane | | Sigma-Aldrich |
| triacrylate (TMPTA) | | |
| White oil (paraffinic- | Ondina ® 933 | Shell |
| naphthenic mineral oil) | | |
| Benzine 60-95 | Exxsol ® DSP 60/95 SH | Exxon Mobil |

### Comparative Example 1

The solid EPDM rubber Vistalon® 6602 in an amount of 4.0 kg/h and a first tackifier resin fraction in the form of 37.5 phr of solid, room-temperature-conditioned Regalite R® 1100 (i.e., the amount of Regalite R® 1100 added was 1.5 kg/h) were fed via a funnel into the filling section of the planetary roller extruder. The wall temperature of the roller cylinder of the planetary roller extruder was 120° C. The central spindle was driven at a speed of 30 revolutions per minute. The mixture was transferred from the filling section into the compounding section. Using a hose pump, the low-viscosity white oil Ondina® 933 was added at 1.5 kg/h in the second roller cylinder, via a side feeder. The remaining quantity of Regalite R® 1100 resin (75 phr) was metered in melted form (tank temperature 130° C.) into the 2^{nd} check ring between the second and third roller cylinders, with a throughput of 3.0 kg/h. The resulting pressure-sensitive adhesive (PSA) had a temperature, at the exit from the planetary roller extruder, of 120° C.

The PSA was subsequently shaped to form a layer 50 μm thick onto a PET carrier 23 μm thick, which was etched with trichloroacetic acid, to produce a single-sided adhesive tape.

The PET carrier was coated here using a 3-roll applicator made up of two adhesive application rolls and a chill roll, with the first adhesive application roll having a temperature of 140° C., the second adhesive application roll a temperature of 120° C., and the chill roll a temperature of less than 10° C. The assembly was subsequently lined with release paper.

To test for homogeneity, approximately 5 g of the PSA were taken after exit from the planetary roller extruder and were pressed between two process liners by means of a hot press at 110° C. and a pressure of 5 bar. The process liners used were PET films 75 μm thick coated on both sides with differently graduated silicone systems. After cooling, the pressed assembly was pulled apart, to give a PSA layer thickness of approximately 50 μm.

The layer was held in front of a lamp, no undigested rubber particles and no unincorporated lubricating components were visible to the eye over an area of 100 cm². The PSA was therefore homogeneous.

### Comparative Example 2

The solid EPDM rubber Vistalon® 6602 in an amount of 2.9 kg/h and a first tackifier resin fraction in the form of 46.9 phr of solid, room-temperature-conditioned Regalite R® 1100 (i.e., the amount of Regalite R® 1100 added was 1.36 kg/h) were fed via a funnel into the filling section of the planetary roller extruder. The wall temperature of the roller cylinder of the planetary roller extruder was 120° C. The central spindle was driven at a speed of 30 revolutions per minute. The liquid EPDM rubber Trilene® 67 was metered in the injection ring by means of a tank melt; for better processing, the tank was heated to 120° C.; the throughput was 2.0 kg/h. Using a hose pump, the low-viscosity white oil Ondina® 933 was added (throughput 1.0 kg/h) as a mixture with TMPTA (throughput 0.1 kg/h) with stirring via a side-feeder in the second roller cylinder. The remaining quantity of Regalite R® 1100 resin (93.8 phr) was metered in melted form (tank temperature 130° C.) into the 2^{nd} check ring between the second and third roller cylinders, with a throughput of 2.72 kg/h.

The resulting pressure-sensitive adhesive (PSA) had a temperature, at the exit from the planetary roller extruder, of 120° C.

In the test for homogeneity, carried out in analogy to comparative example 1, numerous, clearly visible undigested rubber particles were evident to the eye in the PSA layer.

Additionally, the rubber floated in the lubricating components; in other words, unincorporated lubricating components such as tackifier resin were visible. The homogeneity of the PSA was therefore very poor. Accordingly, it was not possible to produce a single-sided adhesive tape amenable to evaluation, by analogy with the protocol from comparative example 1.

### Inventive Example 3

Inventive example 3 differs from comparative example 2 in that the solid EPDM rubber Vistalon® 6602, before being fed to the filling section of the planetary roller extruder, was melted in a single-screw extruder (Blaake single-screw extruder ES45/25D) at 190° C. and therefore fed as a melt into the planetary roller extruder. Furthermore, the entire amount of Regalite R® 1100 resin (140.6 phr) was metered in melted form (tank temperature 130° C.) into the 2^{nd} check ring between the second and third roller cylinders with a throughput of 4.0 kg/h; in other words, no tackifier resin was fed into the filling section of the planetary roller extruder. The wall temperature of the roller cylinders of the planetary roller extruder was 140° C. The central spindle was driven at a speed of 45 revolutions per minute. The resulting PSA at the exit from the planetary roller extruder had a temperature of 100° C. All further details are in line with comparative example 2.

A single-sided adhesive tape was subsequently produced from the PSA as described in comparative example 1.

In the test for homogeneity, carried out in analogy to comparative example 1, no undigested rubber particles and no unincorporated lubricating components were visible to the eye in the PSA. The PSA was therefore homogeneous.

### Comparative Example 4

A PSA was produced with the same composition as in inventive example 3, but by means of the solvent process. In this case, all of the constituents were homogenized as a solvent-based mass in a kneader with double-sigma kneading hook. The solvent used was Benzine 60-95. The kneader was cooled by means of water cooling. First of all, in a first step, the solid EPDM rubber Vistalon® 6602 was admixed with a third of the total Benzine 60-95 to be used, and was preswollen at 23° C. for 12 hours. This so-called preliminary batch was then kneaded for 15 minutes. Next, the tackifier resin Regalite R 1100 was added in three portions with homogeneous kneading for 20 minutes in each case. The Trilene® 67 was added subsequently, with homogeneous kneading for 10 minutes. Thereafter the Ondina® 933 together with TMPTA was added and the mass was kneaded homogeneously for 10 minutes. The PSA was adjusted to a 32 wt % solution by addition of benzene.

The resulting PSA was subsequently coated, on a commercial laboratory coating bench (for example, from the company SMO (Sondermaschinen Oschersleben GmbH)) with the aid of a coating knife, onto a PET carrier 23 μm thick, which was etched with trichloroacetic acid. The solvent was evaporated off in a forced-air drying oven at 105° C. for 10 minutes to dry the PSA. The slot width during coating was set such that the thickness of the PSA layer after evaporation of the solvent was 50 μm. This produced a single-sided adhesive tape.

In the test for homogeneity, carried out in analogy to comparative example 1, no undigested rubber particles and no unincorporated lubricating components were visible to the eye in the PSA. The PSA was therefore homogeneous.

### Inventive Example 5

Inventive example 5 differs from inventive example 3 only in that the solid EPDM rubber used, rather than Vistalon® 6602, was the rubber Royalene® 563, which is notable in particular for a higher ethylene content and therefore a higher crystalline fraction; the fraction of solid EPDM rubber used was the same. All further details are in line with inventive example 3. Again, subsequently, a single-sided adhesive tape was produced from the PSA as described in comparative example 1.

In the test for homogeneity, carried out in analogy to comparative example 1, no undigested rubber particles and no unincorporated lubricating components were visible to the eye in the PSA. The PSA was therefore homogeneous.

### Comparative Example 6

The intention was to produce a PSA having the same composition as in inventive example 5, but by means of the solvent process. Because of the high crystallinity of the solid EPDM rubber Royalene® 563, however, processing with solvents was not possible: Royalene® 563 could not be dissolved. Accordingly it was not possible to produce a single-sided adhesive tape amenable to evaluation in analogy to the protocol from comparative example 4.

Results:

The formulas and results of the inventive and comparative examples are summarized in table 2. Percentages should be understood in each case as percent by weight.

Inventive example 3 shows that via the extrusion process of the invention, by a solvent-free route, it is possible to provide PSAs based on solid EPDM rubber that are homogeneous and at the same time have a high peel adhesion to substrates with different polarities such as, for example, steel and polypropylene (the peel adhesion values in the inventive and comparative examples were each determined on the single-sided adhesion tape produced as described in the respective examples).

A comparison with comparative example 2, in which the solid EPDM rubber was not fed as a melt into the filling section of the planetary roller extruder shows that the prior melting of the solid EPDM rubber is essential in order to produce homogeneous PSAs in the case of differing fractions, and hence including relative low fractions, of solid EPDM rubber. Because of the lack of homogeneity of the PSA from comparative example 2, it was not possible to produce a single-sided adhesive tape amenable to evaluation and so it was not possible to ascertain any peel adhesion values either.

TABLE 2
formulas and results of the inventive and comparative examples.

| | Ex. 1^{a} | Ex. 2^{a} | Ex. 3^{b} | Ex. 4^{a} | Ex. 5^{b} | Ex. 6^{a} |
|---|---|---|---|---|---|---|
| Process | Extru- | Extru- | Extru- | Sol- | Extru- | Sol- |
| | sion | sion | sion | vent | sion | vent |

Formulas

| | | | | | | |
|---|---|---|---|---|---|---|
| Vistalon ® | 40% | 28.8% | 28.8% | 28.8% | | |
| 6602 | | | | | | |
| Royalene ® | | | | | 28.8% | 28.8% |
| 563 | | | | | | |
| Trilene ® 67 | | 19.8% | 19.8% | 19.8% | 19.8% | 19.8% |
| Regalite ® R | 45% | 40.5% | 40.5% | 40.5% | 40.5% | 40.5% |
| 1100 | | | | | | |
| Ondina ® 933 | 15% | 9.9% | 9.9% | 9.9% | 9.9% | 9.9% |
| TMPTA | | 1.0% | 1.0% | 1.0% | 1.0% | 1.0% |
| Fraction of | 40% | 29% | 29%^{c} | 29% | 40%^{c} | 40% |
| solid EPDM | | | | | | |
| Lube fraction^{d} | 60% | 71% | 71% | | 60% | 60% |

Results

| | | | | | | |
|---|---|---|---|---|---|---|
| Homogeneity | + | − | + | + | + | − |
| Peel | 5.4 | | 12.0 | 14.0 | 13.9 | |
| adhesion to | | | | | | |
| steel [N/cm] | | | | | | |
| Peel | 11.9 | | 15.4 | 10.4 | 9.9 | |
| adhesion to | | | | | | |
| PP [N/cm] | | | | | | |
| Micro-shear | 134 | | 308 | 268 | 468 | |
| travel [μm] | | | | | | |
| SAFT [° C.] | 120 | | 94 | 97 | 86 | |

^{a}comparative examples;
^{b}inventive examples;
^{c}melted in the single-screw extruder;
^{d}lube fraction = fraction of lubricating components

Comparative example 1 shows in turn that it is indeed possible to produce homogeneous PSAs via the extrusion process, even without prior melting of the solid EPDM rubber, if the fraction of solid EPDM rubber selected is sufficiently high. In this case, however, the peel adhesion values on substrates with different polarities are much lower, by comparison with relatively low fractions of solid EPDM rubber (cf. the peel adhesion values from comparative example 1 and inventive example 3).

A comparison of inventive example 3 with comparative example 4 shows, moreover, that the extrusion process of the invention provides PSAs whose peel adhesion values on substrates of differing polarities are comparable with the peel adhesion values of the PSAs produced by means of the solvent process (with identical formula). As described above, however, unlike the solvent process, the extrusion process is highly suitable for producing PSA layers with different thicknesses, including, in particular, high thicknesses.

Furthermore, laborious drying is absent from the production process.

A comparison of inventive example 5 with comparative example 6 shows, moreover, that in contrast to the solvent process, the process of the invention also allows the production of homogeneous PSAs based on solid EPDM rubber with a relatively high ethylene content, such as, in particular, more than 55 to 62 wt %. As inventive example 5 shows, homogeneous PSAs can be achieved on the basis of semicrystalline solid EPDMs by the process of the invention even when the fraction of solid EPDM is relatively low.

The TMPTA-containing PSAs of the invention from inventive examples 3 and 5 can optionally be crosslinked by means of electron beams, hence allowing a further increase in the (high-temperature) shear strength.

### Test Methods

All of the measurements were conducted, unless otherwise indicated, at 23° C. and 50% relative humidity. The mechanical and technical adhesive data were ascertained as follows:

### Softening Point Tₛ

The data for the softening point Tₛ, also called softening temperature, especially of oligomeric compounds, polymeric compounds and/or resins, are based on the ring and ball method as per DIN EN 1427:2007 with corresponding application of the provisions (analysis of the oligomer, polymer or resin sample instead of bitumen, with the procedure otherwise retained); the measurements take place in a bath of glycerol.

### Glass Transition Temperature (T_{g})

Glass transition points—referred to synonymously as glass transition temperatures—are reported as the result of measurements by Dynamic Scanning Calorimetry (DSC) in accordance with DIN 53 765, especially sections 7.1 and 8.1, but with uniform heating and cooling rates of 10 K/min in all heating and cooling steps (compare DIN 53 765; section 7.1; note 1). The initial mass of sample is 20 mg.

### Thickness

The thickness of a layer of adhesive can be determined by determining the thickness of a section of such a layer of adhesive, applied to a carrier, said section being of defined length and defined thickness, with subtraction of the thickness of a section of carrier used that has the same dimensions (the carrier thickness being known or separately determinable). The thickness of the layer of adhesive can be determined using commercial thickness gauges (sensor instruments) with accuracies of less than 1 μm deviation. In the present specification, the gauge used is the Mod. 2000 F precision thickness gauge, which has a circular sensor with a diameter of 10 mm (plane). The measurable force is 4 N. The value is read off 1 s after loading. If fluctuations in thickness are determined, the value reported is the average value of measurements at not less than three representative points—in other words, in particular, not including measurement at wrinkles, creases, nibs, and the like.

### 180° Peel Adhesion

The peel strength (peel adhesion) is tested in a method based on PSTC-1.

A pressure-sensitive adhesive tape in the form of a strip 2.0 cm wide is adhered to the test substrate in the form of an ASTM steel plate, by rolling down the tape back and forth five times using a 4 kg roller.

The surface of the steel plate is cleaned with acetone beforehand. The plate is clamped in, and the adhesive strip is pulled off by its free end on a tensile testing sheet at a peel angle of 180° with a velocity of 300 mm/min, and the force required to achieve this is determined.

The results are averaged over three measurements and reported after standardization to the width of the strip, in N/cm.

The peel adhesion on alternative substrates (e.g., polypropylene (PP) or polyethylene (PE)) is determined in accordance with the above methodology, by changing the substrate. The polyethylene and polypropylene substrates are cleaned with ethanol prior to use, and are conditioned under test conditions for 2 hours.

### Molar Weight M_{w}

The weight-average molar weight M_{w} of the liquid EPDM rubber is determined by gel permeation chromatography (GPC). The eluent used is THF with 0.1 vol % trifluoroacetic acid. The measurement is made at 25° C. The precolumn used is PSS-SDV, 5μ, 10³ Å, ID 8.0 mm×50 mm. Separation takes place using the columns PSS-SDV, 5μ, 10³ and also 10⁵ and 10⁶ each with ID 8.0 mm×300 mm. The sample concentration is 4 g/l, the flow rate 1.0 ml per minute. Measurement is made against PMMA standards. (μ=μm; 1 Å=10⁻¹⁰ m).

What is claimed is:

1. A process for the continuous and solvent-free production of a pressure-sensitive adhesive based on solid EPDM rubber in a continuously operating assembly in the form of a planetary roller extruder having a filling section and a compounding section, the compounding section consisting of at least two coupled roller cylinders, by
a) feeding the solid EPDM rubber and any further components into the filling section of the planetary roller extruder,
b) transferring the components from the filling section into the compounding section,
c) adding liquid EPDM rubber, plasticizer, tackifier resin, and any further components to the compounding section, and
d) discharging the resultant pressure-sensitive adhesive,
which process comprises
feeding the solid EPDM rubber as a melt into the filling section.

2. The process as claimed in claim 1,
wherein
the solid EPDM rubber
(i) is composed to an extent of 30 to 80 wt of ethylene,
and/or
(ii) is composed to an extent of 20 to 60 wt % of propylene, and/or
(iii) is composed to an extent of up to 20 wt % of diene,
based in each case on the total weight of the parent monomer composition.

3. The process as claimed in claim 1,
wherein
the solid EPDM rubber as well as ethylene and propylene comprises as diene ethylidene-norbornene (ENB), dicyclopentadiene or 1,4-hexadiene.

4. The process as claimed in claim 1,
wherein
the Mooney viscosity (ML 1+4/125° C.) of the solid EPDM rubber as measured according to DIN 53523 is at least 20 to 120.

5. The process as claimed in claim 1,
wherein
the fraction of solid EPDM rubber in the pressure-sensitive adhesive is at least 15 wt %, based on the total weight of the pressure-sensitive adhesive.

6. The process as claimed in claim 1,
wherein
the liquid EPDM rubber is composed to an extent of 30 to 70 wt %, based in each case on the total weight of the parent monomer composition.

7. The process as claimed in claim 1,
wherein the weight-average molar weight of the liquid EPDM rubber, M_{w}, is ≤100 000 Da.

8. The process as claimed in claim 1,
wherein
the fraction of liquid EPDM rubber in the pressure-sensitive adhesive is up to 30 wt %, based on the total weight of the pressure-sensitive adhesive.

9. The process as claimed in claim 1,
wherein the plasticizer is white oil.

10. The process as claimed in claim 1,
wherein
the fraction of plasticizer in the pressure-sensitive adhesive is up to 20 wt %, based on the total weight of the pressure-sensitive adhesive.

11. The process as claimed in claim 1,
wherein
the pressure-sensitive adhesive comprises 30 to 180 phr of tackifier resin.

12. The process as claimed in claim 1,
wherein
the pressure-sensitive adhesive after discharge from the planetary roller extruder is coated onto a material in web form.

13. The process as claimed in claim 12,
wherein
the pressure-sensitive adhesive is crosslinked in a step downstream of the coating operation, the pressure-sensitive adhesive being crosslinked optionally by means of electron beams.

14. A pressure-sensitive adhesive which is obtainable by a process as claimed in claim 1.

15. A pressure-sensitive adhesive based on solid EPDM rubber which comprises liquid EPDM rubber, plasticizer, and tackifier resin,
wherein
the solid EPDM rubber is composed to an extent of 55 to 75 wt % of ethylene, based on the total weight of the parent monomer composition.

16. A pressure-sensitive adhesive tape which comprises at least one layer of a pressure-sensitive adhesive as claimed in claim 14.

17. A pressure-sensitive adhesive tape which comprises at least one layer of a pressure-sensitive adhesive as claimed in claim 15.
